(19) United States
(12) Patent Application Publication
(10) Pub. No.: US 2005/0082337 A1
(43) Pub. Date: Apr. 21, 2005

(54) Lead-free soft solder, especially electronics solder

(75) Inventor: Edmond Riedl, Gebelkofen (DE)

Correspondence Address: DICKE, BILLIG & CZAJA, PLLC, FIFTH STREET TOWERS, 100 SOUTH FIFTH STREET, MINNEAPOLIS, MN, 55402, US

(73) Assignee: Infineon Technologies AG

(21) Appl. No.: 10/490,918

(22) PCT Filed: Sep. 12, 2002
(86) PCT No.: PCT/DE02/03396

(30) Foreign Application Priority Data
Sep. 26, 2001 (DE) 101 47 378.8

(51) Int. Cl. B23K 35/14

(52) U.S. Cl. 228/56.3

(57) ABSTRACT

The invention relates to a soft solder which includes the alloying constituents bismuth and two of the three metals silver, copper and nickel, wherein bismuth forms between 20% by weight and 99.8% by weight of the alloy, silver forms between 0.1% by weight and 50% by weight of the alloy, copper forms between 0.1% by weight and 30% by weight of the alloy and nickel forms between 0.1% by weight and 30% by weight of the alloy.

### CROSS REFERENCE TO RELATED APPLICATION

This Utility Patent Application claims the benefit of the filing date of Application No. DE 101 47 378.8, filed Sep. 26, 2001 and International Application No. PCT/DE02/03396, filed Sep. 12, 2002, both of which are herein incorporated by reference.

### BACKGROUND

The invention relates to a lead-free soft solder, in particular to an electronics solder.

Soft solders, in particular lead-tin solders, the melting point of which is below 330° C., are used in the electronics sector to produce fixed mechanical and electrical connections. Lead-tin solders used on an industrial scale are standardized, for example, as L-PbSn2 (with a tin content of 2%) to L-Sn90Pb (with a tin content of 90%). In addition, lead-tin solders with an antimony content of from 0.1% to 5% are also used.

Lead-tin solders of this type are also used to solder semiconductor chips in semiconductor fabrication. However, typical alloys have melting ranges which are below the melting point of pure tin (T_{m,Sn}=232° C.). For this reason they are not suitable for applications in which temperatures which are higher than the melting range of the solder occur during operation of the semiconductor component.

However, the thermal demands imposed on electronics and semiconductor components are becoming increasingly severe, since, for example, highly clocked processors with clock frequencies in the gigahertz range can reach very high operating temperatures. This means that in some locations at module level, soldering is no longer carried out using eutectic Pb-62Sn solder (with a melting point of T_{m,Pb-62Sn}=183° C.), but rather silver-containing tin solders which do not contain any lead and therefore melt at high temperatures, for example using tin-silver (SnAg; T_{m,SnAg}=221° C.) or using tin-silver-copper (SnAgCu; T_{m,SnAgCu}=217° C.).

If components are to be processed using these solders, the soldering locations have to be heated to higher temperatures to enable the solder to be reliably liquefied. For an optimum soldering result, a processing temperature of 15 to 30° C. above the melting point of the solder is required. Where components were soldered to system module carriers and printed circuit boards using lead-containing solders at temperatures around 225° C., said lead-free solders have to be processed at temperatures of 260° C. or above.

In order not to cause any damage during processing, the electronics and semiconductor components to be soldered have to be able to withstand temperatures of this level. A temperature limit for the soldering processing of semiconductor chips is 420° C., since most semiconductors are destroyed above this temperature. Many components, for example those used in plastic ball grid arrays or other plastic casings, however, are already damaged even at temperatures much lower than 420° C.

Soldered connections which use solder with a relatively high lead content, for example Pb-5Sn-2Ag (T_{m,Pb-5Sn-2Ag}=288° C.) are used as chip solder to produce soldered connections which are able to withstand the high operating temperatures which occur and which do not cause any damage to the components during processing. However, this alloy has a pronounced ductility and can lead to mechanical failure of the chip soldered joint after only a relatively short operating time.

A further problem with processing lead-containing electronics solders resides in their long-term toxicity, since lead, as a toxic heavy metal, has the ability to build up in living organisms, where it can cause long-term harm. In particular during the processing, i.e., liquefaction of the lead-containing solder, lead vapors are released and have to be filtered out at high cost. However, the lead-containing solders also cause extensive problems during disposal and recycling of electronics scrap.

### SUMMARY

One embodiment of the present invention provides an electronics solder that can satisfy future requirements with regard to thermal stability and environmental compatibility.

In a first variant of the invention, a soft solder that is suitable in particular for use in the electronics sector includes the alloying constituent bismuth (Bi), silver (Ag) and copper (Cu). According to this first variant of the invention, bismuth forms between 20 percent by weight (% by weight) and 99.8 percent by weight of the alloy, silver forms between 0.1% by weight and 50% by weight of the alloy, and copper forms between 0.1% by weight and 30% by weight of the alloy.

This soft solder according to one embodiment of the invention comprising the alloying constituent bismuth, silver and copper does not contain any lead and therefore represents an environmentally friendly solder. Moreover, it has a high mechanical strength and can therefore ensure a reliable connection between metallic surfaces. On account of the fact that the lowest melting point of this soft solder is 258° C., it is suitable for processing temperatures below 420° C. and for joints which must not melt even at operating temperatures of up to 260° C. Consequently, this soft solder can be used to solder together even metals which hitherto had to be soldered using environmentally damaging solders with a high lead content, since only the latter was suitable for relatively high melting points.

With this solder according to one embodiment of the invention, the soldered connection between liquid alloy and the metal parts to be soldered is no longer produced by tin, as has hitherto been the case, but rather by the main component bismuth. The use of bismuth as the main constituent opens up the availability of higher melting temperatures and makes the soldered connection more reliable. The soft solder can be processed using the conventional processes.

According to one embodiment of the invention, bismuth forms between 63% by weight and 77% by weight of the alloy, silver forms between 20 and 30% by weight of the alloy and copper forms between 0.1% by weight and 10% by weight of the alloy. In another embodiment, bismuth forms between 68 and 72% by weight of the alloy, silver forms between 24 and 26% by weight of the alloy, and copper forms between 4.8 and 5.2% by weight of the alloy. According to another embodiment of the soft solder according to the invention, bismuth forms approximately 70% by weight of the alloy, silver forms approximately 25% by weight of the alloy and copper forms approximately 5% by weight of the alloy. In this case, the tolerance range for bismuth and silver in the alloy is in each case ±2% by weight. The tolerance range for copper in the alloy is ±1% by weight. This bismuth-based soft solder (Bi52-Ag36-Cu12, atomic percent) has a solidus temperature of 261° C. and a liquidus temperature of approximately 400° C. and is therefore suitable for soldering electronics components which are subject to high thermal loads, reaching operating temperatures of well over 260° C.

According to another embodiment of the soft solder according to the invention, bismuth forms between 78% by weight and 92% by weight of the alloy, silver forms between 0.1% by weight and 20% by weight of the alloy, and copper forms between 0.1% by weight and 10% by weight of the alloy. In another, bismuth forms between 83 and 87% by weight of the alloy, silver forms between 9 and 11% by weight of the alloy, and copper forms between 4.8 and 5.2% by weight of the alloy. In another embodiment, bismuth forms approximately 85% by weight (±2% by weight) of the alloy, silver forms approximately 10% by weight (±2% by weight) of the alloy, and copper forms approximately 5% by weight (±1% by weight) of the alloy. On account of its lower silver content, the soft solder comprising the alloying constituents in these proportions is inexpensive and is likewise suitable for applications in relatively high temperature ranges, since it has a solidus temperature of 260° C. and a liquidus temperature of approximately 350° C. This soft solder alloy can be described as a Bi70-Ag16-Cu14 (in atomic percent).

According to another embodiment of the soft solder, bismuth forms between 83% by weight and 97% by weight of the alloy, silver forms between 0.1 and 20% by weight of the alloy, and copper forms between 0.1 and 1% by weight of the alloy. In another, bismuth forms between 88 and 92% by weight of the alloy, silver forms between 9 and 11% by weight of the alloy and copper forms between 0.1 and 0.5% by weight of the alloy. In this context, it is particularly preferable for bismuth to form approximately 90% by weight (±2% by weight) of the alloy, for silver to form approximately 10% by weight (±2% by weight) of the alloy and for copper to form approximately 0.1% by weight (±0.1% by weight) of the alloy. This very low-copper soft solder can be referred to as Wi82-Ag18-Cu0.3 (in atomic percent) and has a solidus temperature of 261° C. and a liquidus temperature of approximately 350° C.

According to another form of the soft solder according to the invention, bismuth forms between 83 and 97% by weight of the alloy, silver forms between 0.1 and 10% by weight of the alloy, and copper forms between 0.1 and 10% by weight of the alloy. In another, bismuth forms between 88 and 92% by weight of the alloy, silver forms between 4.8 and 5.2% by weight of the alloy, and copper forms between 4.8 and 5.2% by weight of the alloy. According to another form, bismuth forms approximately 90% by weight (±2% by weight) of the alloy, silver forms approximately 5% by weight (±2% by weight) of the alloy, and copper forms approximately 5% by weight (±1% by weight) of the alloy. This soft solder, which can be described as Wi78-Ag8-Cu14 (in atomic percent), has a solidus temperature of 261° C. and a liquidus temperature of approximately 350° C.

Furthermore, another variant of the invention provides a soft solder, in particular an electronics solder, that includes the alloying constituents bismuth, copper and nickel, with bismuth forming between 40% by weight and 99.8% by weight of the alloy, copper forming between 0.1% by weight and 20% by weight of the alloy and nickel forming between 0.1% by weight and 20% by weight of the alloy. This soft solder according to one embodiment of the invention is particularly suitable for processing temperatures below 420° C. and for joints which must not melt at temperatures up to 260° C., since the solidus temperature is at least 266° C. and the liquidus temperature is between 620° C. and 850° C.

According to another embodiment of the soft solder according to the invention, bismuth forms between 71 and 85% by weight of the alloy, copper forms between 15 and 25% by weight of the alloy, and nickel forms between 0.1 and 5% by weight of the alloy. In another embodiment of the invention bismuth forms between 76 and 80% by weight of the alloy, copper forms between 18.5 and 21.5% by weight of the alloy and nickel forms between 1.8 and 2.2% by weight of the alloy. In another embodiment of the soft solder, bismuth forms approximately 78% by weight (±2% by weight) of the alloy, copper forms approximately 20% by weight (±2% by weight) of the alloy, and nickel forms approximately 2% by weight (±1% by weight) of the alloy. This soft solder can be described as Bi52-Cu43-Ni5 (in atomic percent) and has a solidus temperature of approximately 266° C. and a liquidus temperature of approximately 830 to 850° C.

According to another embodiment of the soft solder according to the invention, bismuth forms between 82 and 96% by weight of the alloy, copper forms between 5 and 15% by weight of the alloy, and nickel forms between 0.1 and 3% by weight of the alloy. In another, bismuth forms between 87 and 91% by weight of the alloy, copper forms between 9 and 11% by weight of the alloy and nickel forms between 0.8 and 1.2% by weight of the alloy. In another embodiment, bismuth forms approximately 89% by weight (±2% by weight) of the alloy, copper forms approximately 10% by weight (±2% by weight) of the alloy, and nickel forms approximately 1% by weight (±0.5% by weight) of the alloy. This soft solder can be described as Bi71-Cu26-Ni3 (in atomic percent) and has a solidus temperature of 266° C. and a liquidus temperature of 720 to 740° C.

According to another embodiment of the soft solder according to the invention, bismuth forms between 78 and 99.8% by weight of the alloy, copper forms between 2 and 8% by weight of the alloy, and nickel forms between 0.1 and 3% by weight of the alloy. In one embodiment, bismuth forms between 92 and 96% by weight of the alloy, copper forms between 4 and 6% by weight of the alloy, and nickel forms between 0.8 and 1.2% by weight of the alloy. According to one embodiment, bismuth forms approximately 94% by weight (±2% by weight) of the alloy, copper forms approximately 5% by weight (±2% by weight) of the alloy, and nickel forms approximately 1% by weight (±0.5% by weight) of the alloy. This soft solder can be characterized as Bi82-Cu15-Ni3 (in atomic percent) and has a solidus temperature of 266° C. and a liquidus temperature of between 620 and 660° C.

According to another embodiment of the soft solder, bismuth forms between 88 and 99.8% by weight of the alloy, copper forms between 2 and 8% by weight of the alloy, and nickel forms approximately 0.1% by weight of the alloy. In one embodiment, bismuth forms between 93 and 97% by weight of the alloy, copper forms between 4 and 6% by weight of the alloy, and nickel forms approximately 0.1% by weight of the alloy. According to one embodiment, bismuth forms approximately 95% by weight (±2% by weight) of the alloy, and copper forms approximately 5% by weight (±2% by weight) of the alloy. The nickel in each case forms 0.1% by weight (±0.05% by weight) of the alloy. This soft solder, which can be described as Bi85-Cu15-Ni0.3 (in atomic percent), has a solidus temperature of 266° C. and a liquidus temperature of 620 to 660° C.

According to another embodiment, a further soft solder according to the invention includes the alloying constituents bismuth, silver and nickel, with bismuth forming between 20% by weight and 99.8% by weight of the alloy, silver forming between 0.1% by weight and 50% by weight of the alloy and nickel forming between 0.1% by weight and 30% by weight of the alloy. This bismuth-silver-nickel solder is suitable for processing temperatures below 420° C. and for joints which must not melt at temperatures of up to 260° C. The solidus temperature of this soft solder is approximately 260° C. and the liquidus temperature between 360° C. and 430° C., depending on the mixing ratio of the alloying constituents.

According to another embodiment of the bismuth-silver-nickel solder, bismuth forms between 61 and 75% by weight of the alloy, silver forms between 25 and 35% by weight of the alloy, and nickel forms between 0.1 and 5% by weight of the alloy. In one embodiment, bismuth forms between 66 and 70% by weight of the alloy, silver forms between 28 and 32% by weight of the alloy and nickel forms between 1.8 and 2.2% by weight of the alloy. According to one embodiment bismuth forms approximately 68% by weight of the alloy, silver forms approximately 30% by weight of the alloy, and nickel forms approximately 2% by weight of the alloy. This Bi51-Ag44-Ni5 (in atomic percent) has a solidus temperature of 260° C. and a liquidus temperature of 430° C.

According to another embodiment of the soft solder, bismuth forms between 71 and 85% by weight of the alloy, silver forms between 15 and 25% by weight of the alloy, and nickel forms between 0.1 and 5% by weight of the alloy. In one embodiment, bismuth forms between 76 and 80% by weight of the alloy, silver forms between 19 and 21% by weight of the alloy and nickel forms between 1.8 and 2.2% by weight of the alloy. According to one embodiment of the invention, bismuth forms approximately 78% by weight of the alloy, silver forms approximately 20% by weight of the alloy and nickel forms approximately 2% by weight of the alloy. This soft solder can be referred to as Bi63-Ag31-Ni6 (in atomic percent) and has a solidus temperature of 260° C. and a liquidus temperature of 410° C.

According to another embodiment of the soft solder, bismuth forms between 81 and 95% by weight of the alloy, silver forms between 5 and 15% by weight of the alloy and nickel forms between 0.1 and 5% by weight of the alloy. In one embodiment, bismuth forms between 86 and 90% by weight of the alloy, silver forms between 8 and 12% by weight of the alloy, and nickel forms between 1.8 and 2.2% by weight of the alloy. According to one embodiment, bismuth forms approximately 88% by weight of the alloy, silver forms approximately 10% by weight of the alloy, and nickel forms approximately 2% by weight of the alloy. This soft solder, which can be referred to as Bi77-Ag17-Ni6, has a solidus temperature of 260° C. and a liquidus temperature of 380° C.

According to another embodiment of the soft solder, bismuth forms between 82 and 97% by weight of the alloy, silver forms between 5 and 15% by weight of the alloy, and nickel forms approximately 0.1% by weight of the alloy. In one embodiment, bismuth forms between 88 and 92% by weight of the alloy, silver forms between 8 and 12% by weight of the alloy and nickel forms approximately 0.1% by weight of the alloy. According to one embodiment of the soft solder, bismuth forms approximately 90% by weight of the alloy, silver forms approximately 10% by weight of the alloy and nickel forms approximately 0.1% by weight of the alloy. This soft solder, which can be referred to as Bi82-Ag18-Ni0.3 (in atomic percent), has a solidus temperature of 260° C. and a liquidus temperature of 360° C.

In all these variants of the soft solder which have been mentioned (Bi—Ag—Cu, Bi—Cu—Ni and Bi—Ag—Ni), bismuth in each case represents the binding main component, so that higher processing temperatures can be achieved compared to conventional tin solders. Moreover, these bismuth solders represent an environmentally friendly alternative with a very high reliability in operation. All the alloys which have been mentioned in accordance with the invention can be processed without problems using existing processing machines.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other.

Like reference numerals designate corresponding similar parts.

FIG. 1 illustrates a binary phase diagram for bismuth and copper.

FIG. 2 illustrates a binary phase diagram for silver and bismuth.

FIG. 3 illustrates a ternary phase diagram for silver, bismuth and copper.

FIG. 4 illustrates a further binary phase diagram for bismuth and copper.

FIG. 5 illustrates a binary phase diagram for bismuth and nickel.

FIG. 6 illustrates a ternary phase diagram for bismuth, copper and nickel.

FIG. 7 illustrates a further binary phase diagram for bismuth and silver.

### DETAILED DESCRIPTION

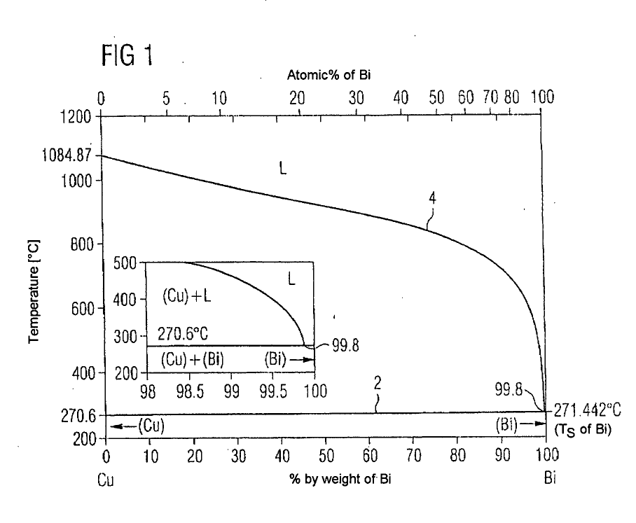

FIG. 1 illustrates a binary phase or equilibrium diagram for bismuth and copper, in which decreasing percentages by weight of copper (Cu) from 100% by weight on the left to 0% by weight on the right are plotted on a lower horizontal axis. Accordingly, increasing percentages by weight of bismuth (Bi) from 100% by weight on the right to 0% by weight on the left are plotted on the same axis. Atomic percentages of bismuth which increase from 0 atomic % on the left to 100 atomic % on the right are plotted on an upper horizontal axis. Temperatures from 200° C. to 1200° C. are plotted on a vertical axis of the diagram.

The diagram illustrates a solidus area below a first solidus line 2, in which both copper and bismuth are in the form of pure crystals. This state of affairs is illustrated in the diagram by the following indication:
(Cu)+(Bi),
where the element symbols are in each case in parentheses (cf. the small excerpt within the diagram). This range lies below a temperature of 270.6° C.

A partial melt, in which individual copper crystals (Cu) are dispersed in a bismuth melt—characterized here as L—is present between the first solidus line 2 and a first liquidus line 4. This relationship is represented by the indication:
(Cu)+L.

As can be seen from the point of intersection between the first liquidus line 4 and the left-hand vertical axis of the diagram, pure copper has a solidification point of 1084.87° C. As the proportion of bismuth in the alloy increases, this melting point drops to a value of 270.6° C. where bismuth forms 99.8% by weight of the alloy (cf. small figure in the center). This alloy composition is illustrated by the point of intersection between the first liquidus line 4 and the first solidus line 2 right by the right-hand vertical axis.

Above the first liquidus line 4, the Bi—Cu alloy is in the form of a pure melt without any individual bismuth or copper crystals. This area is characterized by an “L” in the diagram.

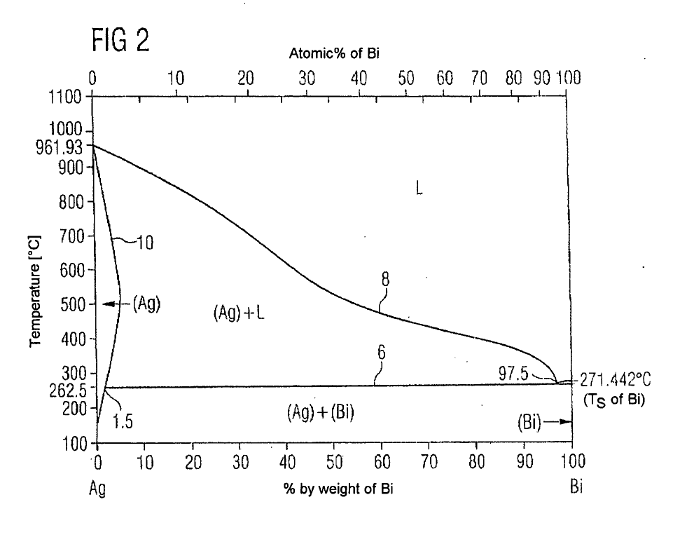

FIG. 2 illustrates a corresponding binary phase diagram for silver and bismuth, in which decreasing percentages by weight of silver (Ag) from 100% by weight on the left to 0% by weight on the right are plotted on a lower horizontal axis of the diagram. Accordingly, decreasing percentages by weight of bismuth (Bi) from 100% by weight on the right to 0% by weight on the left are plotted on the same axis. Increasing atomic percentages of bismuth from 0 atomic % on the left to 100 atomic % on the right are plotted on an upper horizontal axis. Temperatures from 100° C. to 1100° C. are plotted on a vertical axis of the diagram.

The diagram illustrates a solidus area below a second solidus line 6, in which both silver and bismuth are in the form of pure crystals. This state of affairs is illustrated in the diagram by the following indication:
(Ag)+(Bi),
where the element symbols are in each case in parentheses. This area lies below a temperature of 262.5° C.

A partial melt, in which individual silver crystals (Ag) are dispersed in a bismuth melt, characterized here as L, is present between the second solidus line 6 and a second liquidus line 8. This relationship is illustrated by the indication:
(Ag)+L.

As can be seen from the point of intersection between the second liquidus line 8 and the left-hand vertical axis of the diagram, pure silver has a solidification point of 961.93° C. As the bismuth content in the alloy increases, this melting point drops to a value of 262.5° C. where bismuth forms 97.5% by weight of the alloy. This alloy composition is represented by the point of intersection between the second liquidus line 8 and the second solidus line 6 right at the right-hand vertical axis.

Moreover, silver has the property of occurring at what is known as a α-solid solution at high concentrations and at temperatures above approximately 170° C. up to its melting point of approximately 961° C., as illustrated by an area to the left of a slightly convex curve 10 in the diagram.

Above the second liquidus line 8, the bismuth-silver alloy is in the form of a pure melt, which does not contain any individual bismuth or silver crystals, and therefore the metals are completely dissolved. This area is characterized by an “L” in the diagram.

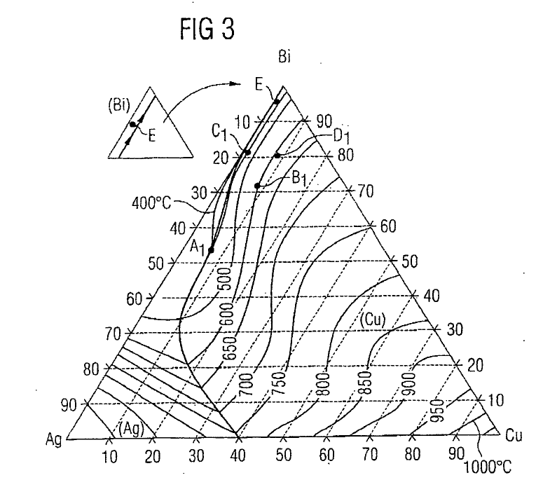

FIG. 3 illustrates a ternary phase diagram for silver, bismuth and copper, in which atomic percentages between 0 and 100 for the three components are plotted on the three axes of the triangle. Decreasing copper concentrations from 100 atomic percent of Cu on the right to 0 atomic percent of Cu on the left are plotted on the horizontal axis. Decreasing silver concentrations from 100 atomic % of Ag at the bottom to 0 atomic % of Ag at the top are plotted on the left-hand axis sloping up to the right. Decreasing bismuth concentrations from 100 atomic % of Bi at the top to 0 atomic % of Bi at the bottom are plotted on the right-hand axis which slopes downward to the left.

Temperature lines are plotted within the three axes. A pronounced third liquidus line 12, at which the temperature lines each have a pronounced kink, can be seen in the left-hand half of the triangle enclosed by the three axes.

Four different points A1, B1, C1 and D1 are plotted in this diagram, characterizing the four alloy compositions compiled in the table below.

| | Solidus | |
|---|---|---|
| | temperature | Liquidus temperature |
| Alloys | [° C.] | [° C.] |
| A1: Bi52-Ag36-Cu12 | 261 | Approximately 400 |
| [atomic %] | | |
| B1: Bi70-Ag16-Cu14 | 261 | Approximately 350 |
| [atomic %] | | |
| C1: Bi82-Ag18-Cu0.3 | 261 | Approximately 350 |
| [atomic %] | | |
| D1: Bi78-Ag8-Cu14 | 261 | Approximately 350 |
| [atomic %] | | |

Alloy A1 (Bi52-Ag36-Cu12) contains approximately 70% by weight (±2% by weight) of bismuth, approximately 25% by weight (±2% by weight) of silver and approximately 5% by weight (±1% by weight) of copper. Alloy B1 (Bi70-Ag16-Cu14) contains approximately 85% by weight (±2% by weight) of bismuth, approximately 10% by weight (±2% by weight) of silver and approximately 5% by weight (±1% by weight) of copper. Alloy C1 (Bi82-Ag18-Cu0.3) contains approximately 90% by weight (±2% by weight) of bismuth, approximately 10% by weight (±2% by weight) of silver and approximately 0.1% by weight (±0.1% by weight) of copper. Alloy D1 (Bi78-Ag8-Cu14) contains approximately 90% by weight (±2% by weight) of bismuth, approximately 5% by weight (±2% by weight) of silver and approximately 5% by weight (±1% by weight) of copper.

The plotted alloys A1 to D1 can if appropriate be understood as wider ranges which may therefore adopt a larger area than that illustrated in the diagram.

An enlarged excerpt from the apex of the triangle illustrated by the diagram illustrates a point E at which the three components in crystalline form at a temperature of approximately 258° C. are in each case in equilibrium with the melt L, as indicated by the following reaction scheme
E:L<=>(Ag)+(Bi)+(Cu).

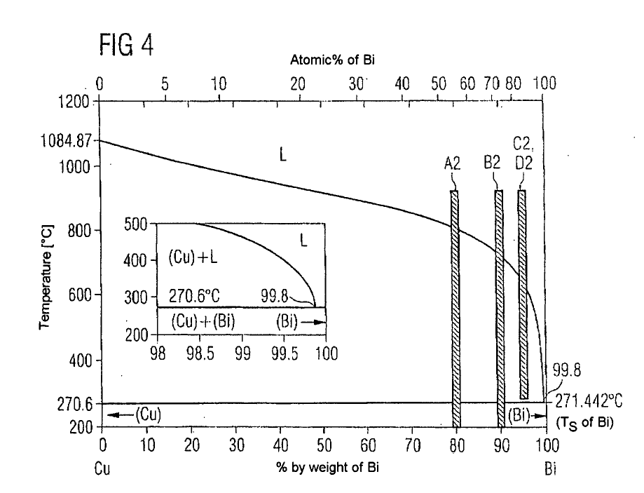

FIG. 4 illustrates a binary phase diagram for bismuth and copper corresponding to that shown in FIG. 1, but in this case preferred alloy compositions A2, B2, C2 and D2 in accordance with the following table are also included in the drawing.

| | Solidus | Liquidus |
|---|---|---|
| | temperature | temperature |
| Alloys | [° C.] | [° C.] |
| A2: Bi52-Cu43-Ni5 | 266 | 830 . . . 850 |
| [atomic %] | | |
| B2: Bi71-Cu26-Ni3 | 266 | 720 . . . 740 |
| [atomic %] | | |
| C2: Bi82-Cu15-Ni3 | 266 | 620 . . . 660 |
| [atomic %] | | |
| D2: Bi85-Cu15-Ni0.3 | 266 | 620 . . . 660 |
| [atomic %] | | |

Alloy A2 (Bi52-Cu43-Ni5) contains approximately 78% by weight (±2% by weight) of bismuth, approximately 20% by weight (±2% by weight) of copper and approximately 2% by weight (±1% by weight) of nickel. Alloy B2 (Bi71-Cu26-Ni3) contains approximately 89% by weight (±2% by weight) of bismuth, approximately 10% by weight (±2% by weight) of copper and approximately 1% by weight (±0.5% by weight) of nickel. Alloy C2 (Bi82-Cu15-Ni3) contains approximately 94% by weight (±2% by weight) of bismuth, approximately 5% by weight (±2% by weight) of copper and approximately 1% by weight (±0.5% by weight) of nickel. Alloy D2 (Bi85-Cu15-Ni0.3) contains approximately 95% by weight (±2% by weight) of bismuth, approximately 5% by weight (±2% by weight) of copper and approximately 0.1% by weight (±0.05% by weight) of nickel.

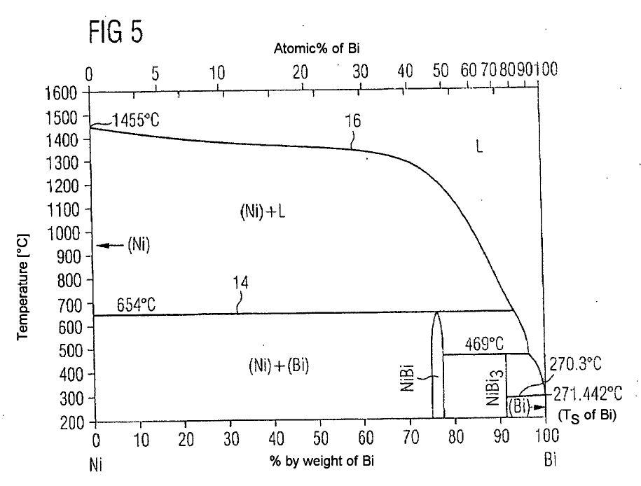

Furthermore, FIG. 5 illustrates a binary phase diagram for bismuth and nickel, in which decreasing percentages by weight of nickel (Ni) from 100% by weight on the left to 0% by weight on the right are plotted on a lower horizontal axis of the diagram. Accordingly, decreasing percentages by weight of bismuth (Bi) from 100% by weight on the right to 0% by weight on the left are plotted on the same axis. Increasing atomic percentages of bismuth from 0 atomic % on the left to 100 atomic % on the right are plotted on an upper horizontal axis. Temperatures from 200° C. to 1600° C. are plotted on a vertical axis of the diagram.

The diagram illustrates a solidus area below a third solidus line 14, in which both nickel and bismuth are in the form of pure crystals. This state of affairs is illustrated in the diagram by the following indication:
(Ni)+(Bi),
where the element symbols are in each case in parentheses. This solidus area lies below a temperature of 654° C.

A partial melt, in which individual nickel crystals (Ni) are dispersed in a bismuth melt, characterized here as L, is present between the third solidus line 14 and a fourth liquidus line 16. This relationship is illustrated by the indication:
(Ni)+L.

As can be seen from the point of intersection between the fourth liquidus line 16 and the left-hand vertical axis of the diagram, pure nickel has a solidification point of 1455° C. As the proportion of bismuth in the alloy increases, this melting point decreases in a number of stages to less than 200° C. where bismuth forms 99.8% by weight of the alloy.

In a range where bismuth forms between approximately 74% by weight and 77% by weight, at temperatures below 654° C. an intermetallic phase NiBi is formed, which tapers to a point below and toward the third solidus line 14.

Therefore, at temperatures just below 654° C., the intermetallic phase is only established with a very precise ratio of nickel to bismuth.

To the right of the intermetallic phase NiBi there is a eutectic 18 at a temperature of 469° C., characterized by a horizontal line. A further intermetallic phase NiBi₃ is formed at a fixed mixing ratio of approximately 90% by weight of Bi below the eutectic 18, i.e. at temperatures of less than 469° C.

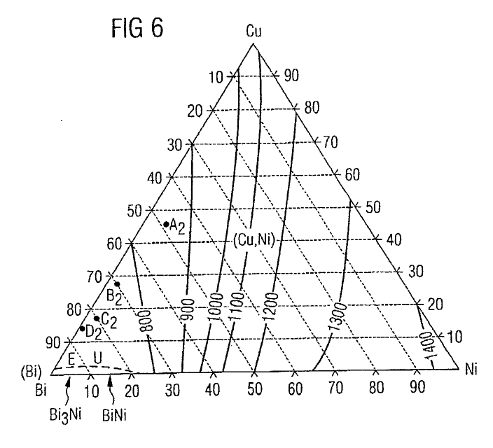

FIG. 6 illustrates a ternary phase diagram for bismuth, copper and nickel, in which atomic percentages of between 0 and 100 for the three components are plotted on the respective three axes of the triangle. Decreasing concentrations of nickel from 100 atomic % of Ni on the right to 0 atomic % of Ni on the left are plotted on the horizontal axis. Decreasing concentrations of bismuth from 100 atomic % of Bi at the bottom to 0 atomic % of Bi at the top are plotted on the left-hand axis, which slopes up and to the right. Decreasing concentrations of copper from 100 atomic % of Cu at the top to 0 atomic % of Cu at the bottom are plotted on the right-hand axis which slopes down and to the left.

Temperature lines are visible within the three axes. In this case, there is no solidus line as in FIG. 3, and therefore continuous temperature curves are plotted.

An interrupted curve which characterizes various transition states between the pure crystals, the intermetallic phases which occur and the melt, is illustrated in a bottom left-hand corner area of the diagram:
E:L<=>(Bi)+Bi₃Ni+(Cu, Ni)
U:L+BiNi<=>Bi₃Ni+(Cu,Ni)

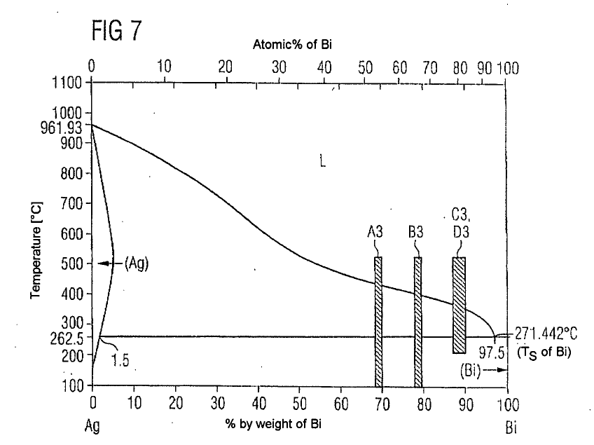

Finally, FIG. 7 illustrates a further binary phase diagram for silver and bismuth corresponding to that shown in FIG. 2, but in this case preferred alloy compositions A3, B3, C3 and D3 in accordance with the following table are also included in the drawing.

| | Solidus | Liquidus |
|---|---|---|
| | temperature | temperature |
| Alloys | [° C.] | [° C.] |
| A3: Bi51-Ag44-Ni5 | 260 | 430 |
| [atomic %] | | |
| B3: Bi63-Ag31-Ni6 | 260 | 410 |
| [atomic %] | | |
| C3: Bi77-Ag17-Ni6 | 260 | 380 |
| [atomic %] | | |
| D3: Bi82-Ag18-Ni0.3 | 260 | 360 |
| [atomic %] | | |

Alloy A3 (Bi51-Ag44-Ni5) contains approximately 68% by weight (±2% by weight) of bismuth, approximately 30% by weight (±2% by weight) of silver and approximately 2% by weight (±1% by weight) of nickel. Alloy B3 (Bi63-Ag31-Ni6) contains approximately 78% by weight (±2% by weight) of bismuth, approximately 20% by weight (±2% by weight) of silver and approximately 2% by weight (±1% by weight) of nickel. Alloy C3 (Bi77-Ag17-Ni6) contains approximately 88% by weight (±2% by weight) of bismuth, approximately 10% by weight (±2% by weight) of silver and approximately 2% by weight (±1% by weight) of nickel. Alloy D3 (Bi82-Ag18-Ni0.3) contains approximately 90% by weight (±2% by weight) of bismuth, approximately 10% by weight (±2% by weight) of silver and approximately 0.1% by weight (±0.01% by weight) of nickel.

The plotted alloys A1 to D1 plotted can if appropriate be understood as wider ranges which may therefore adopt a larger area than that illustrated in the diagram.

1. A soft solder, in particular an electronics solder, comprising:
alloying constituents bismuth, silver and copper, wherein bismuth forms between about 20% by weight and about 99.8% by weight of the alloy, silver forms between about 0.1% by weight and about 50% by weight of the alloy, and copper forms between about 0.1% by weight and about 30% by weight of the alloy.

2. The soft solder of claim 1, wherein bismuth forms between about 63% by weight and about 77% by weight of the alloy, silver forms between about 20% by weight and about 30% by weight of the alloy, and copper forms between about 0.1% by weight and about 10% by weight of the alloy.

3. The soft solder of claim 1, wherein bismuth forms between about 68% by weight and about 72% by weight of the alloy, silver forms between about 24% by weight and about 26% by weight of the alloy, and copper forms between about 4.8% by weight and about 5.2% by weight of the alloy.

4. The soft solder of claims 1, wherein bismuth forms about 70% by weight of the alloy, silver forms about 25% by weight of the alloy and copper forms about 5% by weight of the alloy.

5. The soft solder of claim 1, wherein bismuth forms between about 78% by weight and about 92% by weight of the alloy, silver forms between about 0.1% by weight and about 20% by weight of the alloy, and copper forms between about 0.1% by weight and about 10% by weight of the alloy.

6. The soft solder of claim 1, wherein bismuth forms between about 83% by weight and about 87% by weight of the alloy, silver forms between about 9% by weight and about 11% by weight of the alloy and copper forms between about 4.8% by weight and about 5.2% by weight of the alloy.

7. The soft solder of claims 1, wherein bismuth forms about 85% by weight of the alloy, silver forms about 10% by weight of the alloy and copper forms about 5% by weight of the alloy.

8. The soft solder of claim 1, wherein bismuth forms between about 83% by weight and about 97% by weight of the alloy, silver forms between about 0.1% by weight and about 20% by weight of the alloy and copper forms between about 0.1% by weight and about 1% by weight of the alloy.

9. The soft solder of claim 1, wherein bismuth forms between about 88% by weight and about 92% by weight of the alloy, silver forms between about 9% by weight and about 11% by weight of the alloy, and copper forms between about 0.1% by weight and about 0.5% by weight of the alloy.

10. The soft solder of claim 1, wherein bismuth forms about 90% by weight of the alloy, silver forms about 10% by weight of the alloy and copper forms about 0.1% by weight of the alloy.

11. The soft solder of claim 1, wherein bismuth forms between about 83% by weight and about 97% by weight of the alloy, silver forms between about 0.1% by weight and about 10% by weight of the alloy, and copper forms between about 0.1% by weight and about 10% by weight of the alloy.

12. The soft solder of claim 1, wherein bismuth forms between about 88% by weight and about 92% by weight of the alloy, silver forms between about 4.8% by weight and about 5.2% by weight of the alloy, and copper forms between about 4.8% by weight and about 5.2% by weight of the alloy.

13. The soft solder of claims 1, wherein bismuth forms about 90% by weight of the alloy, silver forms about 5% by weight of the alloy and copper forms about 5% by weight of the alloy.

14. A soft solder, in particular an electronics solder, comprising:
alloying constituents bismuth, copper and nickel, wherein bismuth forms between about 40% by weight and about 99.8% by weight of the alloy, copper forms between about 0.1% by weight and about 20% by weight of the alloy and nickel forms between about 0.1% by weight and about 20% by weight of the alloy.

15. The soft solder of claim 14, wherein bismuth forms between about 71% by weight and about 85% by weight of the alloy, copper forms between about 15% by weight and about 25% by weight of the alloy and nickel forms between about 0.1% by weight and about 5% by weight of the alloy.

16. The soft solder of claim 14, wherein bismuth forms between about 76% by weight and about 80% by weight of the alloy, copper forms between about 18.5% by weight and about 21.5% by weight of the alloy and nickel forms between about 1.8% by weight and about 2.2% by weight of the alloy.

17. The soft solder of claim 14, wherein bismuth forms about 78% by weight of the alloy, copper forms about 20% by weight of the alloy and nickel forms about 2% by weight of the alloy.

18. The soft solder of claim 14, wherein bismuth forms between about 82% by weight and about 96% by weight of the alloy, copper forms between about 5% by weight and about 15% by weight of the alloy and nickel forms between about 0.1% by weight and about 3% by weight of the alloy.

19. The soft solder of claim 14, wherein bismuth forms between about 87% by weight and about 91% by weight of the alloy, copper forms between about 9% by weight and about 11% by weight of the alloy and nickel forms between about 0.8% by weight and about 1.2% by weight of the alloy.

20. The soft solder of claim 14, wherein bismuth forms about 89% by weight of the alloy, copper forms about 10% by weight of the alloy and nickel forms about 1% by weight of the alloy.

21. The soft solder of claim 14, wherein bismuth forms between about 87% by weight and about 99.8% by weight of the alloy, copper forms between about 2% by weight and about 8% by weight of the alloy and nickel forms between about 0.1% by weight and about 3% by weight of the alloy.

22. The soft solder of claim 14, wherein bismuth forms between about 92% by weight and about 96% by weight of the alloy, copper forms between about 4% by weight and about 6% by weight of the alloy and nickel forms between about 0.8% by weight and about 1.2% by weight of the alloy.

23. The soft solder of claim 14, wherein bismuth forms about 94% by weight of the alloy, copper forms about 5% by weight of the alloy and nickel forms about 1% by weight of the alloy.

24. The soft solder of claim 14, wherein bismuth forms between about 88% by weight and about 99.8% by weight of the alloy, copper forms between about 2% by weight and about 8% by weight of the alloy and nickel forms about 0.1% by weight of the alloy.

25. The soft solder of claim 14, wherein bismuth forms between about 93% by weight and about 97% by weight of the alloy, copper forms between about 4% by weight and about 6% by weight of the alloy and nickel forms about 0.1% by weight of the alloy.

26. The soft solder of claim 14, wherein bismuth forms about 95% by weight of the alloy, copper forms about 5% by weight of the alloy and nickel forms about 0.1% by weight of the alloy.

27. A soft solder, in particular an electronics solder, comprising:
alloying constituents bismuth, silver and nickel, wherein bismuth forms between about 20% by weight and about 99.8% by weight of the alloy, silver forms between about 0.1% by weight and about 50% by weight of the alloy and nickel forms between about 0.1% by weight and about 30% by weight of the alloy.

28. The soft solder of claim 27, wherein bismuth forms between about 61% by weight and about 75% by weight of the alloy, silver forms between about 25% by weight and about 35% by weight of the alloy and nickel forms between about 0.1% by weight and about 5% by weight of the alloy.

29. The soft solder of claim 27, wherein bismuth forms between about 66% by weight and about 70% by weight of the alloy, silver forms between about 28% by weight and about 32% by weight of the alloy and nickel forms between about 1.8% by weight and about 2.2% by weight of the alloy.

30. The soft solder of claim 27, wherein bismuth forms about 68% by weight of the alloy, silver forms about 30% by weight of the alloy and nickel forms about 2% by weight of the alloy.

31. The soft solder of claim 27, wherein bismuth forms between about 71% by weight and about 85% by weight of the alloy, silver forms between about 15% by weight and about 25% by weight of the alloy and nickel forms between about 0.1% by weight and about 5% by weight of the alloy.

32. The soft solder of claim 27, wherein bismuth forms between about 76% by weight and about 80% by weight of the alloy, silver forms between about 19% by weight and about 21% by weight of the alloy and nickel forms between about 1.8% by weight and about 2.2% by weight of the alloy.

33. The soft solder of claim 27, wherein bismuth forms about 78% by weight of the alloy, silver forms about 20% by weight of the alloy and nickel forms about 2% by weight of the alloy.

34. The soft solder of claim 27, wherein bismuth forms between about 81% by weight and about 95% by weight of the alloy, silver forms between about 5% by weight and about 15% by weight of the alloy and nickel forms between about 0.1% by weight and 5% by weight of the alloy.

35. The soft solder of claim 27, wherein bismuth forms between about 86% by weight and about 90% by weight of the alloy, silver forms between about 8% by weight and about 12% by weight of the alloy, and nickel forms between about 1.8% by weight and about 2.2% by weight of the alloy.

36. The soft solder of claim 27, wherein bismuth forms about 88% by weight of the alloy, silver forms about 10% by weight of the alloy and nickel forms about 2% by weight of the alloy.

37. The soft solder of claim 27, wherein bismuth forms between about 82% by weight about 97% by weight of the alloy, silver forms between about 5% by weight and about 15% by weight of the alloy and nickel forms about 0.1% by weight of the alloy.

38. The soft solder of claim 27, wherein bismuth forms between about 88% by weight and about 92% by weight of the alloy, silver forms between about 8% by weight and about 12% by weight of the alloy, and nickel forms about 0.1% by weight of the alloy.

39. The soft solder of claim 27, wherein bismuth forms about 90% by weight of the alloy, silver forms about 10% by weight of the alloy and nickel forms about 0.1% by weight of the alloy.
